(19) United States
(12) Patent Application Publication
(10) Pub. No.: US 2022/0191220 A1
(43) Pub. Date: Jun. 16, 2022

(54) ANALYSIS SYSTEM, METHOD, AND PROGRAM

(71) Applicant: NEC Corporation, Minato-ku, Tokyo (JP)

(72) Inventor: Noboru NAGATANI, Minato-Tokyo (JP)

(73) Assignee: NEC Corporation, Minato-ku, Tokyo (JP)

(21) Appl. No.: 17/439,994

(22) PCT Filed: Feb. 7, 2020
(86) PCT No.: PCT/JP2020/004814

§ 371 Date: Sep. 16, 2021

(30) Foreign Application Priority Data
Mar. 28, 2019 (JP) 2019-063597

(51) Int. Cl. H04L 9/40; G06F 21/53

(52) U.S. Cl. CPC H04L 63/1416; G06F 2221/034; G06F 21/53

(57) ABSTRACT

Provided is an analysis system that can display attack routes so that a security administrator can easily determine which attack routes is prioritized for dealing with. The topology identification unit 4 identifies a network topology of devices included in the system to be diagnosed. The detection unit 5 detects attack routes that indicate flows of attacks that can be executed in the system to be diagnosed, based on security information about each device. The display control unit 6 displays the attack routes on a display device by superimposing the attack routes on the network topology. At this time, the display control unit 6 displays the attack routes on the display device in a manner that corresponds to impact on the system to be diagnosed.

### TECHNICAL FIELD

The present invention relates to an analysis system, an analysis method, and an analysis program that display information that can be used as a basis for making decisions about how to deal with an attack on a system to be diagnosed.

### BACKGROUND ART

It is required for, information processing systems that include the plurality of computers, to take security measures to protect information assets from cyber attacks. The security measures include assessing the vulnerability and the like of the target system and removing vulnerabilities as necessary.

PLT 1 describes a security diagnosis system that lists the identification numbers of intrusion routes and displays the designated intrusion routes on a map.

PLT 2 describes a vulnerability assessment tool that uses a simulator to assess vulnerability testing on a system consisting of computers connected to a network.

### CITATION LIST

### Patent Literature

PLT 1: Japanese Patent Application Laid-Open No. 2008-257577

PLT 2: Japanese Patent Application Laid-Open No. 2003-108521

### SUMMARY OF INVENTION

### Technical Problem

The system that is the target of the security diagnosis is referred to as the system to be diagnosed.

It is common to assess the impact of each vulnerability in order to take security-related measures.

However, since the configuration of each system to be diagnosed is different, it is difficult to grasp the impact of an attack on the system to be diagnosed only by assessing the impact of the vulnerability.

Therefore, it is an object of the present invention to provide an analysis system, an analysis method, and an analysis program that can evaluate threats to security according to the configuration of the system to be diagnosed.

### Solution to Problem

An analysis system according to the present invention virtualizes a system to be diagnosed and performs a simulation, and comprises a topology identification unit that identifies a network topology of devices included in the system to be diagnosed; a detection unit that detects attack routes that indicate flows of attacks that can be executed in the system to be diagnosed, based on security information about each device; and, a display control unit that displays the attack routes on a display device by superimposing the attack routes on the network topology, wherein the display control unit displays the attack routes on the display device in a manner that corresponds to impact on the system to be diagnosed.

An analysis method according to the present invention is an analysis method of virtualizing a system to be diagnosed and performing a simulation, implemented by a computer, comprises: identifying a network topology of devices included in the system to be diagnosed; detecting attack routes that indicate flows of attacks that can be executed in the system to be diagnosed, based on security information about each device; and, displaying the attack routes on a display device by superimposing the attack routes on the network topology, wherein when displaying the attack routes on the display device the computer displays the attack routes on the display device in a manner that corresponds to impact on the system to be diagnosed.

The analysis program according to the present invention is an analysis program for causing a computer to virtualize a system to be diagnosed and performs a simulation, the analysis program for causing the computer to execute: a topology identification process of identifying a network topology of devices included in the system to be diagnosed; a detection process of detecting attack routes that indicate flows of attacks that can be executed in the system to be diagnosed, based on security information about each device; and, a display control process of displaying the attack routes on a display device by superimposing the attack routes on the network topology, wherein the analysis program causes the computer to execute, in the display control process, displaying the attack routes on the display device in a manner that corresponds to impact on the system to be diagnosed. The present invention may also be a computer-readable recording medium in which the analysis program described above is recorded.

### Advantageous Effects of Invention

According to this invention, it is possible to evaluate threats to security according to the configuration of the system to be diagnosed.

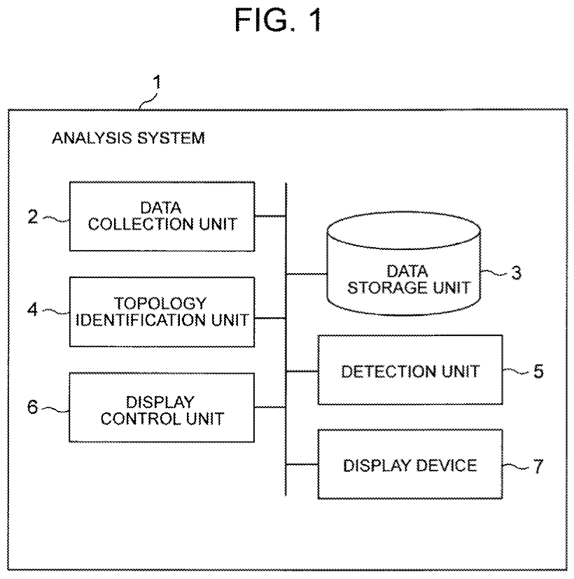

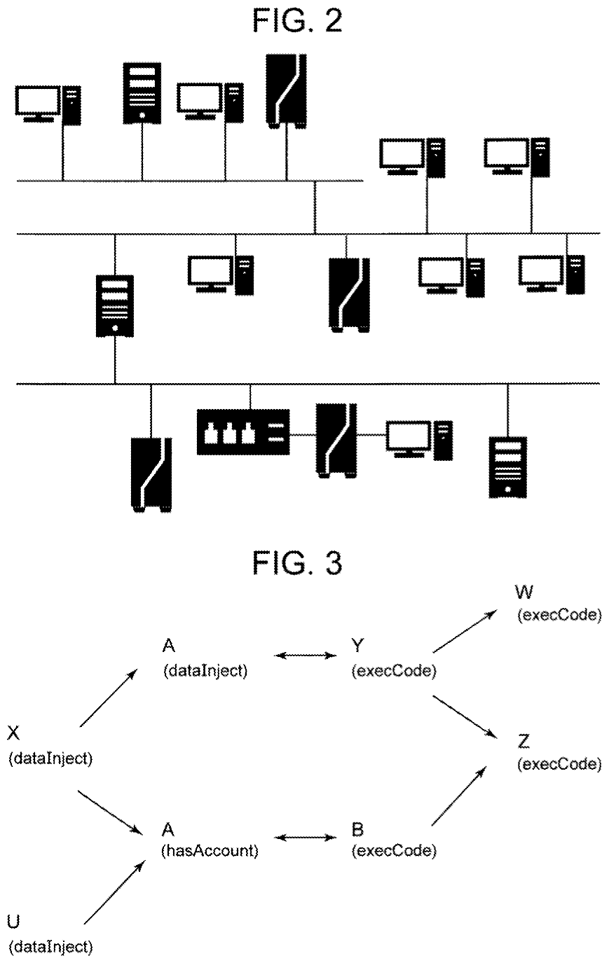

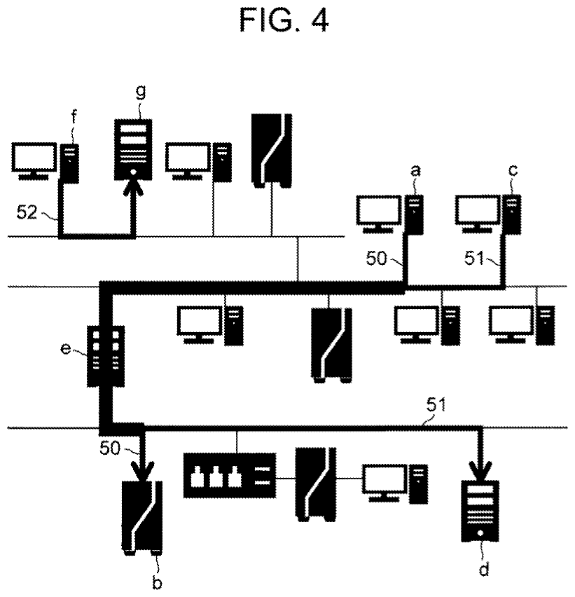

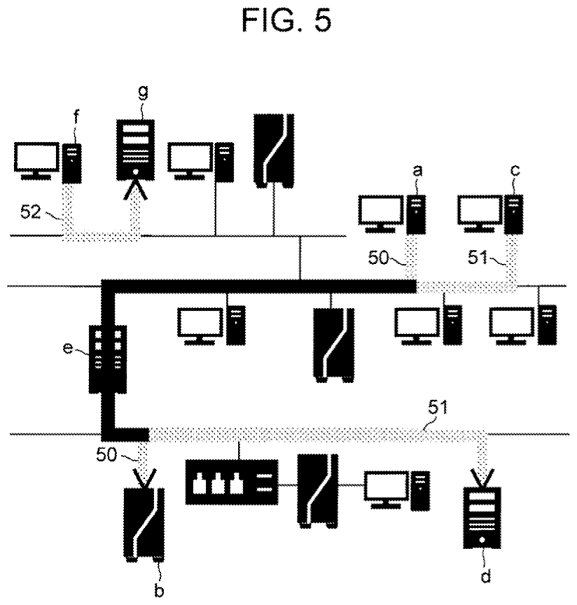

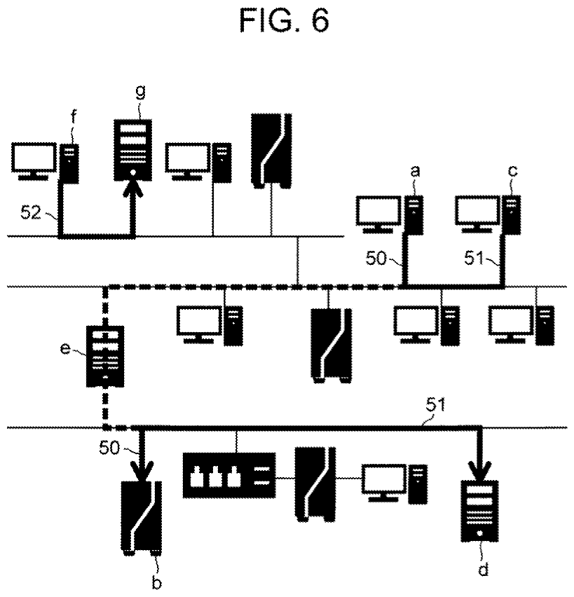

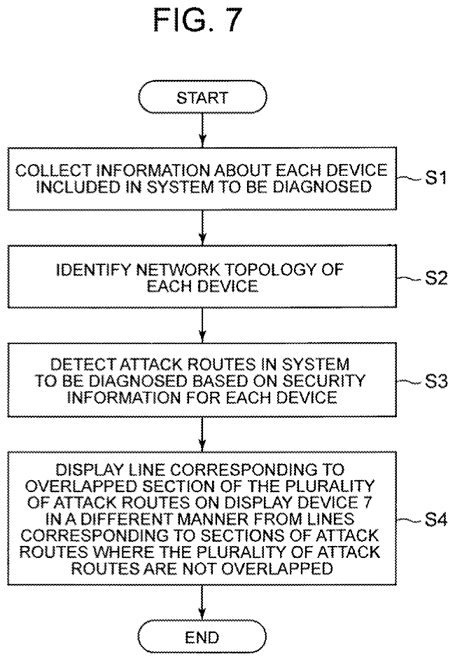

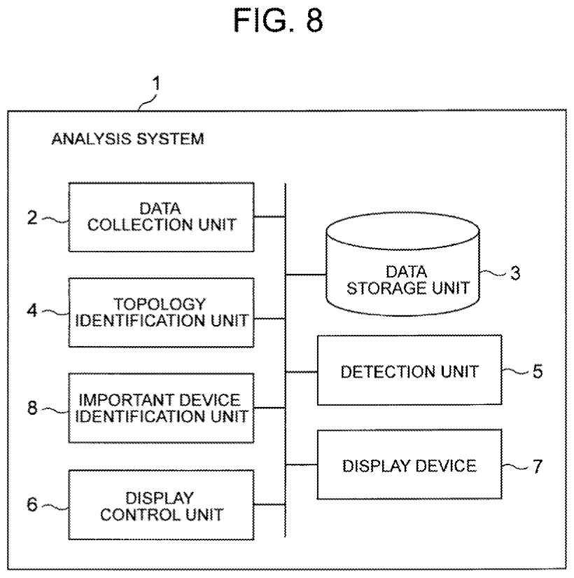

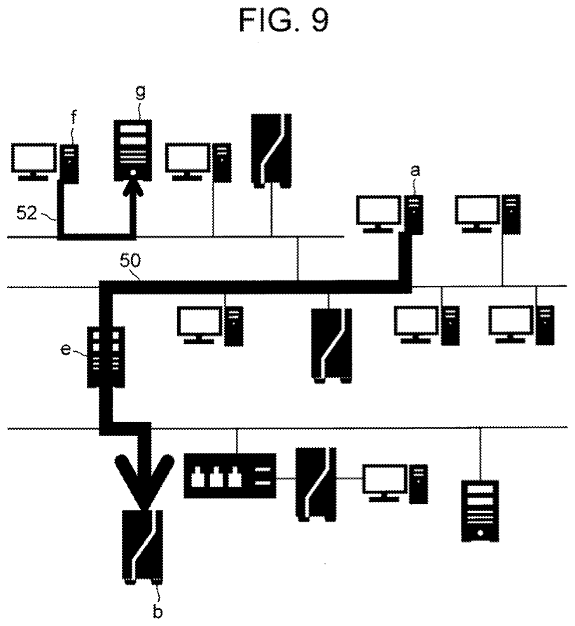

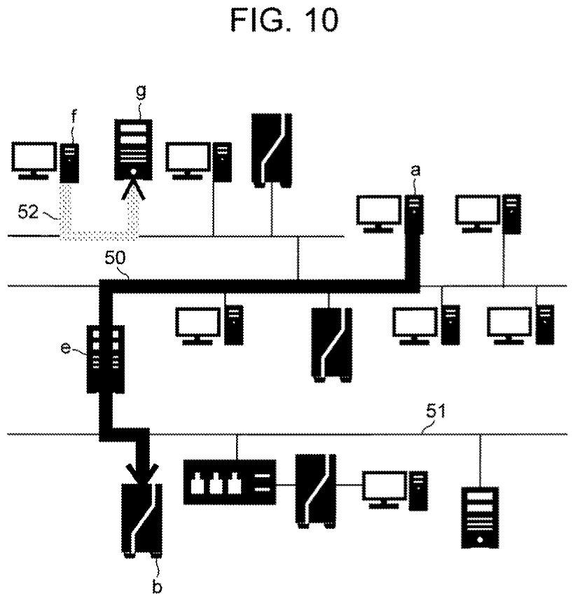

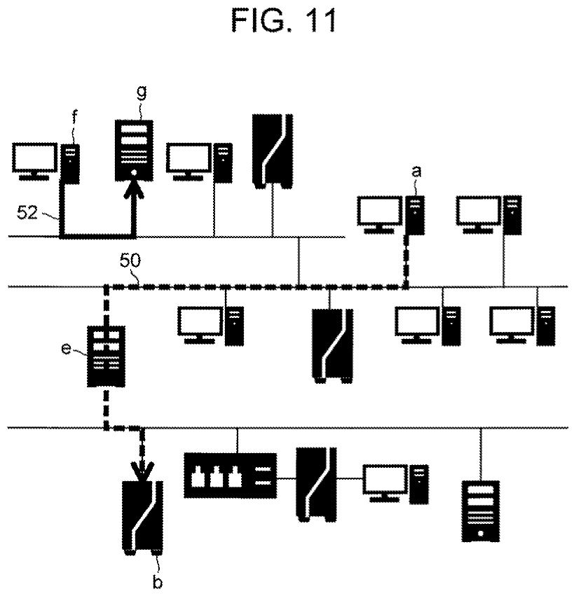

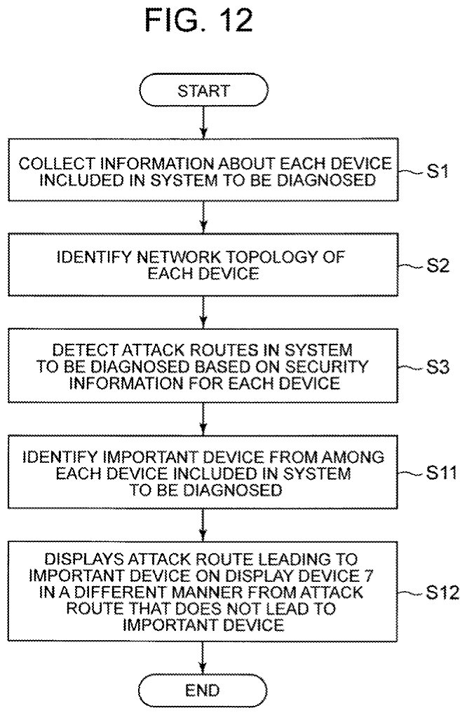

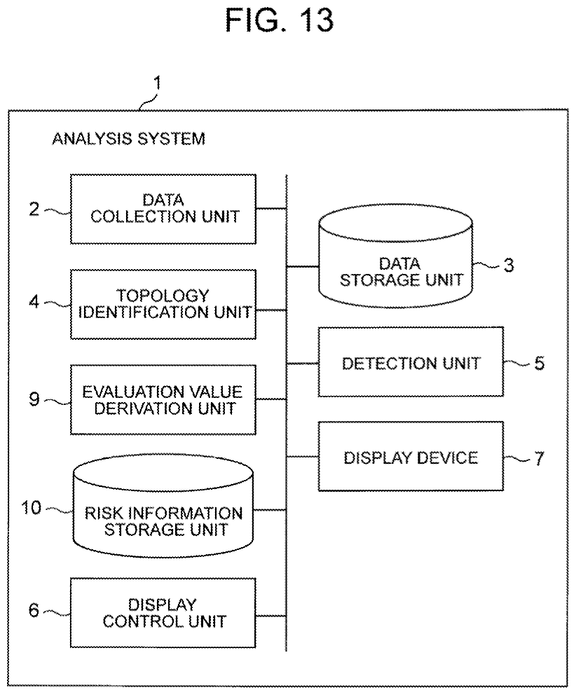

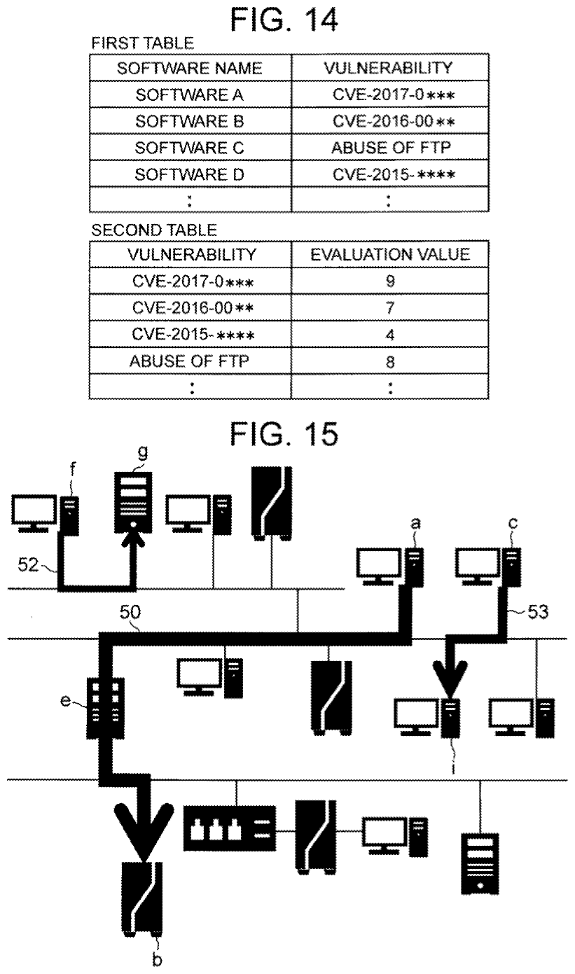

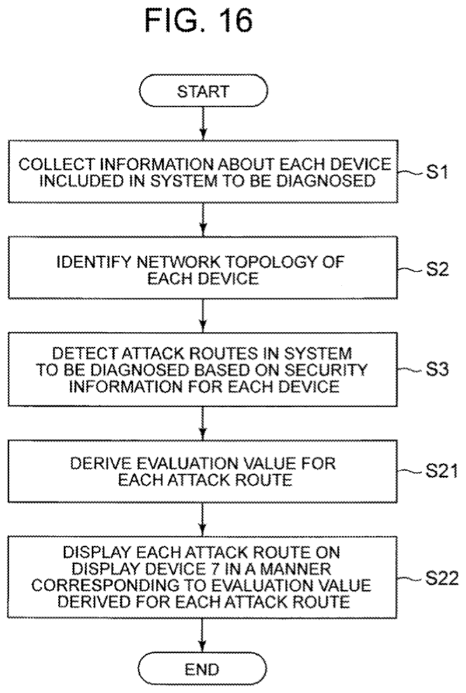

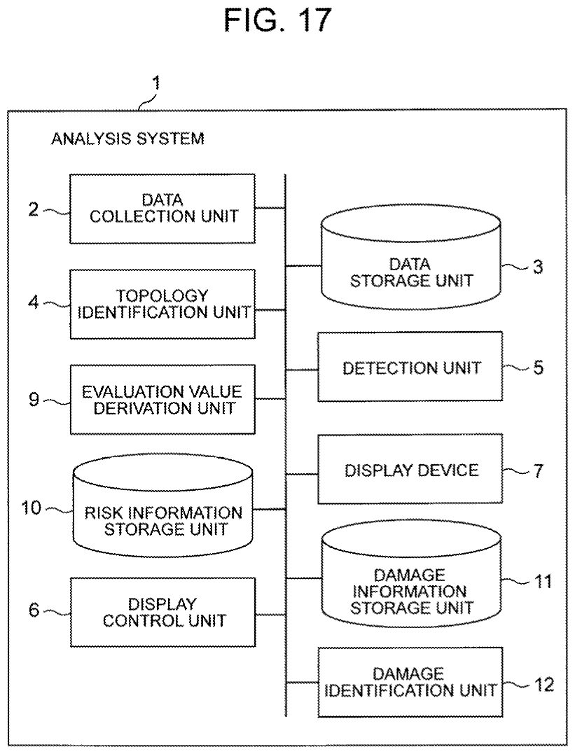

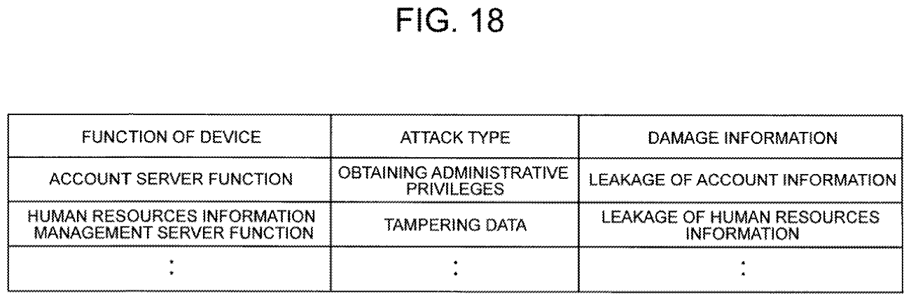

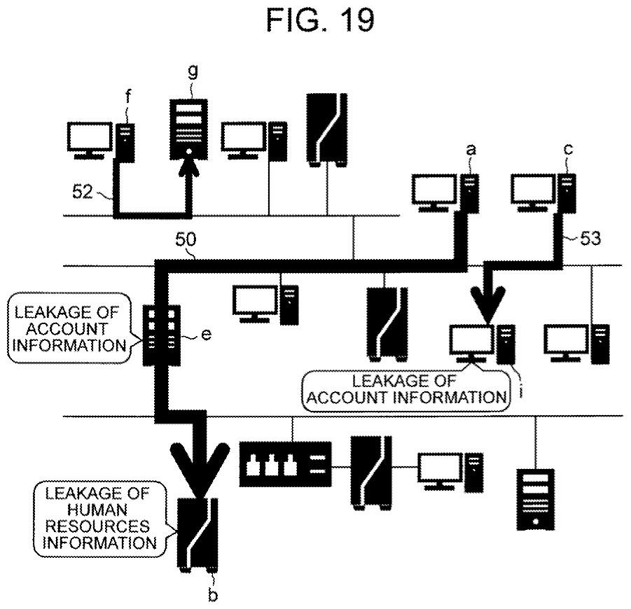

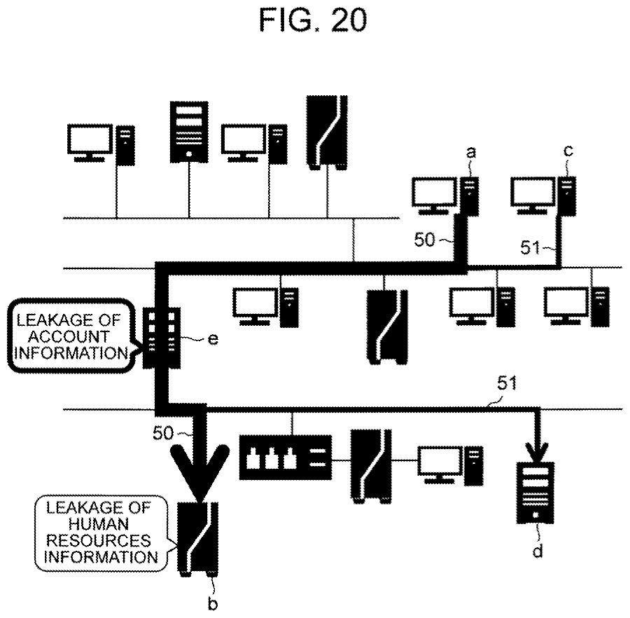

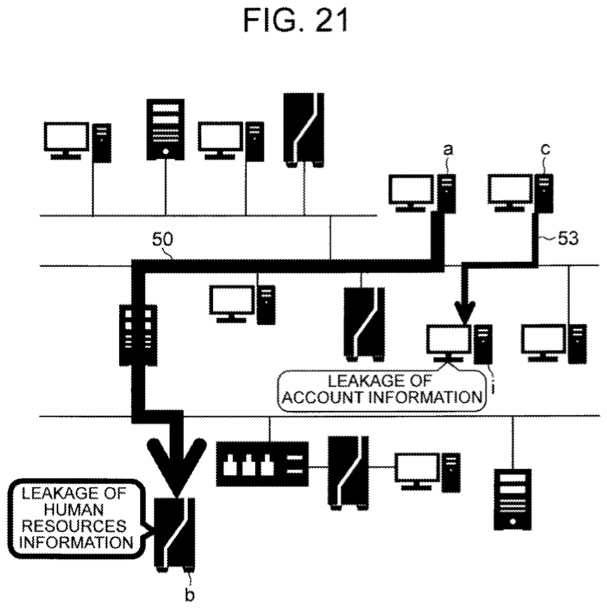

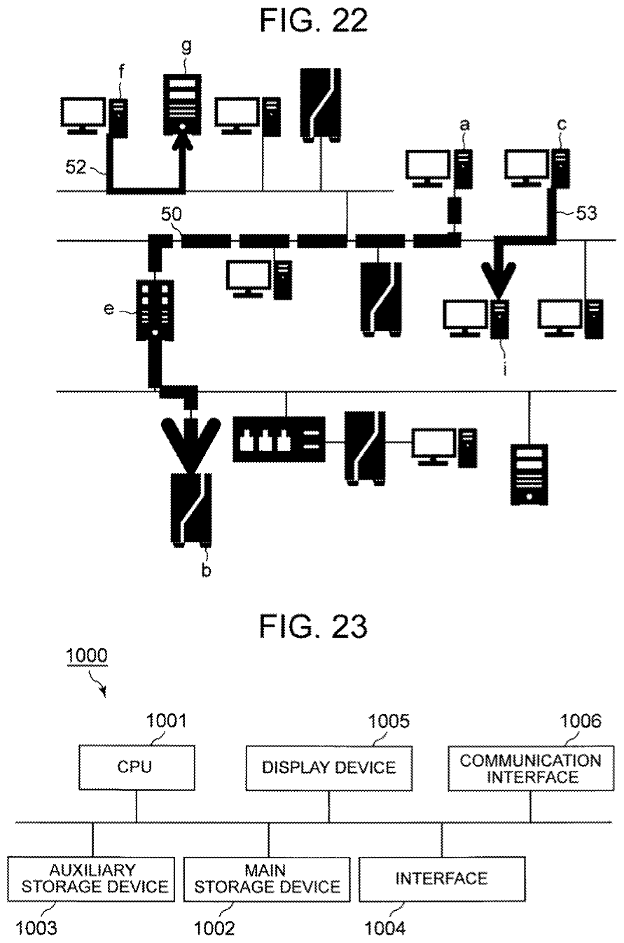

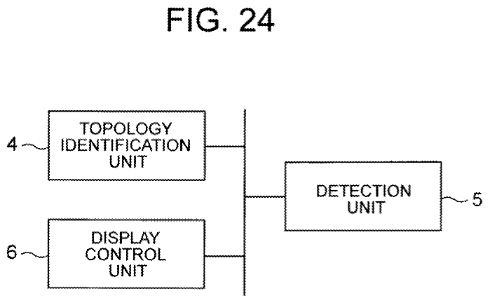

### BRIEF DESCRIPTION OF DRAWING

[FIG. 1] It is a block diagram of an example of the analysis system of the first example embodiment of the present invention.

[FIG. 2] It is a schematic diagram depicting an example of a network topology identified by the topology identification unit.

[FIG. 3] It is a schematic diagram depicting an example of information showing the plurality of transition relationships of a “combination of device and attack state”.

[FIG. 4] It is a schematic diagram depicting a display example in the first example embodiment.

[FIG. 5] It is a schematic diagram depicting another display example in the first example embodiment.

[FIG. 6] It is a schematic diagram depicting another display example in the first example embodiment.

[FIG. 7] It is a flowchart depicting an example of the processing process of the analysis system of the first example embodiment.

[FIG. 8] It is a block diagram of an example of the analysis system of the second example embodiment of the present invention.

[FIG. 9] It is a schematic diagram depicting a display example in the second example embodiment.

[FIG. 10] It is a schematic diagram depicting another display example in the second example embodiment.

[FIG. 11] It is a schematic diagram depicting another display example in the second example embodiment.

[FIG. 12] It is a flowchart depicting an example of the processing process of the analysis system of the second example embodiment.

[FIG. 13] It is a block diagram of an example of the analysis system of the third example embodiment of the present invention.

[FIG. 14] It is a schematic diagram depicting an example of information stored in the risk information storage unit.

[FIG. 15] It is a schematic diagram depicting a display example in the third example embodiment.

[FIG. 16] It is a flowchart depicting an example of the processing process of the analysis system of the third example embodiment.

[FIG. 17] It is a block diagram of a variation of the third example embodiment.

[FIG. 18] It is a schematic diagram depicting an example of information stored in the damage information storage unit.

[FIG. 19] It is a schematic diagram depicting a display example in a variation of the third example embodiment.

[FIG. 20] It is a schematic diagram depicting an example of highlighting damage information for a device on the plurality of attack routes.

[FIG. 21] It is a schematic diagram depicting an example of highlighting damage information regarding an important device.

[FIG. 22] It is a schematic diagram depicting an example of particularly highlighting an attack route, if an evaluation value of the attack route leading to an important device is large.

[FIG. 23] It is a schematic block diagram of a computer configuration for the analysis system of each example embodiment of the present invention.

[FIG. 24] It is a block diagram depicting an overview of an analysis system according to the present invention.

### DESCRIPTION OF EMBODIMENTS

Example embodiments of the present invention will be described below, with reference to the drawings.

### Example Embodiment 1

FIG. 1 is a block diagram of an example of the analysis system of the first example embodiment of the present invention. The analysis system 1 of the first example embodiment includes a data collection unit 2, a data storage unit 3, a topology identification unit 4, a detection unit 5, a display control unit 6, and a display device 7.

It is assumed that the analysis system in each of the example embodiments of the present invention virtualizes the system to be diagnosed and performs simulations based on the information of each device and other information to analyze the system to be diagnosed.

The data collection unit 2 collects information on each device included in the system to be diagnosed (the system that is the target of the security diagnosis).

Examples of systems to be diagnosed include, for example, IT (Information Technology) systems in companies and so-called OT (Operational Technology) systems for controlling factories and plants and the like. However, the systems to be diagnosed are not limited to these systems. A system in which the plurality of devices are connected via a communication network can be a system to be diagnosed.

Each device included in the system to be diagnosed is connected via a communication network. Examples of devices included in the system to be diagnosed include personal computers, servers, switches, routers, machine tools installed in factories, and control devices for machine tools. However, devices are not limited to the above examples. The devices may be physical devices or virtual devices.

Examples of information collected by the data collection unit 2 include, for example, information on the operating system (OS) installed in the device and its version, information on the hardware configuration installed in the device, information on the software installed in the device and its version, information on the communication data exchanged between the device and other devices and the communication protocol used to exchange the communication data, and information on the status of the ports of the device (which ports are open) and the like. The communication data includes information on the source and destination of the communication data. However, the examples of information collected by the data collection unit 2 are not limited to the above examples, and the data collection unit 2 may collect other information as information about the device.

The data collection unit 2 may collect information about the devices directly from each device included in the system to be diagnosed. In this case, the analysis system 1 is connected to each device via a communication network, and the data collection unit 2 may collect information from each device via the communication network.

Alternatively, the data collection unit 2 may obtain information about each device from an information collection server that collects information about each device. In this case, the analysis system 1 is connected to the information collection server via a communication network, and the data collection unit 2 may collect information about each device from the information collection server via the communication network.

If each device is equipped with an agent, the data collection unit 2 may collect information about each device via the agent, or it may obtain information about each device from an information collection server that has collected information about each device via the agent.

An agent installed in each device may respectively transmit information about the device to an information collection server, and the data collection unit 2 may collect information about each device included in the system to be diagnosed from the information collection server. In this case, for example, the analysis system 1 is connected to the information collection server via a communication network, and the data collection unit 2 may collect information about each device from that information collection server via the communication network.

When the data collection unit 2 collects information about each device included in the system to be diagnosed, it stores the information in the data storage unit 3.

The data storage unit 3 is a storage device that stores the information about each device collected by the data collection unit 2.

The topology identification unit 4 identifies the network topology of each device. Specifically, the topology identification unit 4 may identify the network topology of each device based on the network topology configuration given by the security administrator (hereinafter referred to simply as the administrator), or it may identify the network topology of each device based on the information about each device stored in the data storage unit 3. FIG. 2 is a schematic diagram depicting an example of a network topology identified by the topology identification unit 4. FIG. 2 indicates a situation in which the plurality of devices are connected via a communication network.

The detection unit 5 detects the attack routes in the system to be diagnosed based on the security information about each device stored in the data storage unit 3. Specifically, the security information about the devices includes the security support status of the devices.

The attack route indicates the flow of an attack that can be executed in the system to be diagnosed. Specifically, the attack route is a route that indicates the order of the devices to be attacked, from the device that is the starting point of the attack to the device that is the end point of the attack.

The detection unit 5 may detect the attack route based on the security information about each device and the predefined analysis rules.

For example, the detection unit 5 may detect the attack route using the following method.

First of all, there are the plurality of types of attacks, and the attacks that a device may be subjected to vary depending on the vulnerabilities it has. Therefore, in each example embodiment of the present invention, the state of a device that may be attacked due to vulnerability is defined as an attack state. For example, an attack state can be defined as “a state in which code can be executed (hereinafter referred to as “execCode”)”, “a state in which data can be tampered with (hereinafter referred to as “dataInject”)”, “a state in which files can be accessed (hereinafter referred to as “accessFile”)”, “a state in which account information is held (hereinafter referred to as “hasAccount”)”, “a state in which DoS (Denial of Service) attacks can be performed”, etc.

The information that indicates the transition from one “combination of device and attack state” to another “combination of device and attack state” is called an attack scenario. The transition from one “combination of device and attack state” to another “combination of device and attack state” indicates that one attack becomes possible on one device, and another attack becomes possible on that device or another device. The detection unit 5 detects possible attack scenarios in the system to be diagnosed, based on the security information for each device and the predefined analysis rules. Specifically, the detection unit 5 detects attack scenarios according to whether the security information for each device matches the conditions indicated by the analysis rules. The detection unit 5 considers the “combination of devices and attack states” as a node in the plurality of detected attack scenarios, and obtains information indicating the plurality of transition relationships of the “combination of devices and attack states” by connecting the common node. FIG. 3 is a schematic diagram depicting an example of this information. In FIG. 3, “A”, “B”, “U”, “W”,. “X”, “Y”, and “Z” represent devices, respectively. Here, the case, where the information shown in FIG. 3 is obtained, will be explained as an example.

The detection unit 5 accepts the designation of the analysis target from the administrator via the user interface (not shown). The analysis target may be a device that is the starting point of an attack, a device that is the end point of an attack, or a combination of the two. Also, the plurality of analysis targets may be designated. The detection unit 5 detects the attack route based on the information (see FIG. 3) that indicates the plurality of transition relationships of “combination of device and attack state” for the analysis target specified by the administrator.

For example, if the administrator designates a device X as the starting point of the attack and a device Z as the end point of the attack, the detection unit 5 can detect the attack route “X→A→Y→Z” (hereinafter referred to as attack route 1), and the attack route “X→A→B→Z” (hereinafter referred to as attack route 2) based on the information schematically shown in FIG. 3. In this way, even if one starting point and one ending point are designated, the plurality of attack routes may exist.

For example, if the administrator designates a device X as the starting point of the attack and a device W as the end point of the attack, the detection unit 5 can detect the attack route “X→A→Y→W” based on the information schematically shown in FIG. 3.

This method is an example of how the detection unit 5 detects attack routes.

In the above method, even if there are common devices on different attack routes, the attack states of the devices are not necessarily identical. Since a device may have the plurality of vulnerabilities, or a single vulnerability may result in the plurality of attacks, the attack state of the common devices on different attack routes may be different. For example, in the above attack route 1, the attack state of device A is “dataInject”, and in the above attack route 2, the attack state of device A is “hasAccount” (see FIG. 3).

In addition, the attack route is not always detected for the analysis target designated by the administrator. For example, if an administrator designates a device Z as the starting point of an attack and a device X as the end point of an attack, no attack route will be detected (see FIG. 3). This means that there is no attack from device Z to device X.

When the administrator designates only the starting point, the detection unit 5 may set the important device described below as the end point. When the administrator designates only the endpoint, the detection unit 5 may set a predetermined terminal that has a high possibility of being the starting point as the starting point.

The display control unit 6 displays the attack routes on the display device 7 by superimposing them on the network topology identified by the topology identification unit 4. At this time, the display control unit 6 displays the attack routes detected by the detection unit 5 on the display device 7 in a manner that corresponds to the impact of the attack on the system to be diagnosed.

For example, the display control unit 6 may highlight the attack routes where the impact of the attack on the system to be diagnosed is significant, or it may highlight the devices that exist on the attack routes where the impact of the attack on the system to be diagnosed is significant.

In this example embodiment, the display control unit 6 displays the overlapped section of the plurality of attack routes on the display device 7 in a different manner from the sections of the attack routes where the plurality of attack routes are not overlapped. The devices that exist in the overlapped sections of the plurality of attack routes will be the target of attacks by the plurality of attack routes. Therefore, it can be said that the impact of devices that exist in the overlapped sections of the plurality of attack routes is significant. As described above, the display control unit 6 emphasizes the areas that are heavily affected by the attack by displaying the overlapped section of the plurality of attack routes in a different manner from the sections of the attack routes where the plurality of attack routes are not overlapped. Such a display will emphasize devices that are often used in attacks or that can easily be used as a stepping stone. As a result, the administrator will be able to grasp the areas that are used in many attacks, making it easier for the administrator to determine which ones to prioritize to deal with.

For example, the display control unit 6 may display the overlapped section of the plurality of attack routes on the display device 7 in a manner different from the sections on the attack route where the plurality of attack routes are not overlapped. More specifically, for example, the display control unit 6 may display the line corresponding to the overlapped section of the plurality of attack routes as a thicker line than the lines corresponding to the sections on the attack route where the plurality of attack routes are not overlapped. An example of such a display is shown in FIG. 4.

In the example shown in FIG. 4, the display control unit 6 displays the attack route “device a→device e→device b” (hereinafter referred to as attack route 50, denoted by the sign “50”), the attack route “device c→device e→device d” (hereinafter referred to as attack route 51, denoted by the sign “51”). The display control unit 6 also displays the attack route “device f→device g” (hereinafter referred to as attack route 52, denoted by the code “52”). And the display control unit 6 displays the line corresponding to the overlapped section of the attack routes 50 and 51 thicker than the lines corresponding to the non-overlapped sections of the attack routes 50 and 51. Also, attack route 52 has no overlapped sections with other attack routes, and the display control unit 6 displays attack route 52 with a line of the same thickness as the lines corresponding to the non-overlapped sections in attack routes 50 and 51.

After confirming the display shown in FIG. 4, the administrator can easily determine that the attack routes 50 and 51, which have overlapped section, should be prioritized over the attack route 52, and in particular, the attack on the device e that exists in the overlapped section should be prioritized. Examples of how to deal with an attack are “patch the software that has the vulnerability used in the attack” or “close a specific port” etc.

The example shown in FIG. 4 shows a case where the display control unit 6 displays the overlapped section of the plurality of attack routes in a different thickness from the sections on the attack route where the plurality of attack routes are not overlapped. The display control unit 6 may display the overlapped section of the plurality of attack routes in a different color from the sections where the plurality of attack routes are not overlapped. An example of the display in this case is shown in FIG. 5. FIG. 5 illustrates a display in which the display control unit 6 emphasizes the common section of the attack routes by displaying the line corresponding to the overlapped section of the attack routes 50, 51 in a darker color than the lines corresponding to the non-overlapped sections in the attack routes 50, 51.

The display control unit 6 may display the overlapped section of the plurality of attack routes with a different line type from the sections on the attack route where the plurality of attack routes are not overlapped. An example of the display in this case is shown in FIG. 6. In FIG. 6, the display control unit 6 displays the line corresponding to the overlapped section of the attack routes 50 and 51 as dotted lines, and the lines corresponding to the non-overlapped sections in the attack routes 50 and 51 as solid lines, thereby illustrating a display that emphasizes the common section of the attack routes. In FIG. 6, a case where the common section of the attack routes is emphasized by dotted lines is illustrated, but the line type of the emphasized section may be changed appropriately according to the visibility and the degree of emphasis.

In the above example embodiment, an example in which the display control unit 6 highlights the overlapped section of the attack routes has been shown, but it may also highlight the devices that exist in the common section of the plurality of attack routes. For example, the display control unit 6 may display the devices that exist in the common section of the plurality of attack routes in a different color from the other devices, or in a different line type from the other devices.

The display device 7 is a device that displays information, and can be a general display device. If the analysis system 1 exists in the cloud, the display device 7 may be a display device of a terminal connected to the cloud.

The data collection unit 2 is realized, for example, by a CPU (Central Processing Unit) of a computer that operates according to an analysis program and a communication interface of the computer. For example, the CPU may read the analysis program from a program recording medium such as a program storage device of the computer, and operate as the data collection unit 2 according to the program and using the communication interface of the computer. The topology identification unit 4, the detection unit 5, and the display control unit 6 are realized, for example, by the CPU of the computer operating according to the analysis program. For example, the CPU may read an analysis program from a program recording medium as described above, and operate as the topology identification unit 4, detection unit 5, and display control unit 6 according to the program. The data storage unit 3 is realized, for example, by a storage device included in the computer.

Next, the processing process will be explained. FIG. 7 is a flowchart depicting an example of the processing process of the analysis system 1 of the first example embodiment. The matters already explained are omitted.

First, the data collection unit 2 collects information about each device included in the system to be diagnosed (Step S1). The data collection unit 2 stores the collected information in the data storage unit 3.

Next, the topology identification unit 4 identifies the network topology of each device (Step S2).

Next, the detection unit 5 detects the attack routes in the system to be diagnosed based on the security information for each device (Step S3).

Next, the display control unit 6 superimposes on the network topology and displays the line corresponding to the overlapped section of the plurality of attack routes on the display device 7 in a different manner from the lines corresponding to the sections of the attack routes where the plurality of attack routes are not overlapped (Step S4).

According to this example embodiment, as described above, the display control unit 6 displays the line corresponding to the overlapped section of the plurality of attack routes on the display device 7 in a different manner from the lines corresponding to the sections on the attack routes where the plurality of attack routes are not overlapped. This display will emphasize devices that are often used in attacks or that are easily used as stepping stones. Therefore, the administrator can grasp the areas that are used in many attacks, and it becomes easier for the administrator to determine what should be dealt with as a priority. Then, depending on the configuration of the system to be diagnosed, each attack route is detected, and the display control unit 6 displays each attack route in the manner described above. Therefore, it is possible to evaluate the threats to security according to the configuration of the system to be diagnosed. The assessment in each example embodiment of the present invention is not an assessment of the vulnerability itself, but an assessment of the entire system to be diagnosed, which has a unique configuration. Therefore, it is possible to find problems according to the magnitude of the impact on the target system and to take measures against them.

Various variations of the first example embodiment are shown below.

If an overlapped section of the plurality of attack routes exists, and the attack state of the devices in that overlapped section is different for each of those attack routes, the display control unit 6 may display each of those attack routes separately, instead of displaying the overlapped section of the attack routes together.

When displaying the overlapped section of the plurality of attack routes in a different manner from the sections on the attack routes where the plural attack routes are not overlapped, the display control unit 6 may change the thickness or the color of the overlapped section, for example, depending on the situation. For example, if the number of overlapped attack routes is equal to or less than a certain number, the display control unit 6 may change the thickness of the overlapped section and the thickness of the non-overlapped section, and if the number of overlapped attack routes exceeds the certain number, the color of the overlapped section and the color of the non-overlapped section may be changed. In the above example, you may reverse the display method when the number of overlapped attack routes is equal to or less than the certain number and when it is not.

If there are many attack routes, there may be the plurality of sets of attack routes with overlapped section. In such a case, the display control unit 6 may change the display method of the overlapped section for each set of attack routes that have overlapped section. For example, the display control unit 6 may change the thickness of the overlapped section and the thickness of the non-overlapped section for one set of attack routes, and change the color of the overlapped section and the color of the non-overlapped section for another set of attack routes.

The display control unit 6 may change the way the overlapped section is displayed depending on the number of devices displayed on the screen. For example, if the number of devices displayed on the screen is equal to or less than a certain number, the display control unit 6 may change the thickness of the overlapped section and the thickness of the non-overlapped section, and if the number of devices displayed on the screen exceeds the certain number, the color and line type of the overlapped section and the color and line type of the non-overlapped section may be changed.

In the first example embodiment, the display control unit 6 may display the overlapped section of the plurality of attack routes in such a way that it is less conspicuous than the sections on the attack route where the plurality of attack routes are not overlapped. Examples of inconspicuous display include displaying it as thin line, or displaying it in a color that is lighter or less conspicuous than other lines.

### Example Embodiment 2

FIG. 8 is a block diagram of an example of the analysis system of the second example embodiment of the present invention. Elements similar to those of the first example embodiment are indicated with the same sign as in FIG. 1. The analysis system 1 of the second example embodiment includes a data collection unit 2, a data storage unit 3, a topology identification unit 4, a detection unit 5, an important device identification unit 8, a display control unit 6, and a display device 7.

The data collection unit 2, the data storage unit 3, the topology identification unit 4, the detection unit 5, and the display device 7 are the same as those elements in the first example embodiment, and the explanations are omitted.

The important device identification unit 8 identifies an important device from among each device included in the system to be diagnosed. Here, the important device is a device that is important in the system to be diagnosed and that is undesirable to be attacked. The administrator may decide in advance what types of devices are considered important devices. In this example, an account server that holds the plurality of account information (set of ID and password) is used as an example of an important device. However, devices other than account servers may be used as important devices. For example, a storage device that stores confidential information may be considered an important device. Also, there may be more than one type of device that corresponds to an important device, and one system may have more than one device that corresponds to an important device.

The important device identification unit 8 may, for example, identify an important device by receiving the designation of device that corresponds to an important device from the administrator via a user interface (not shown) among each device included in the system to be diagnosed.

In addition, the important device identification unit 8 may identify important devices based on the information about each device collected by the data collection unit 2, without being designated by the administrator. The following description is an example of a case where the important device identification unit 8 identifies one of the devices included in the system to be diagnosed as an account server, which is an example of an important device.

The account server is equipped with software for the account server. The account server also transfers communication data to and from other devices using a predetermined protocol. In addition, for example, the account server has a predetermined port open. Therefore, for example, based on the information about each device, the important device identification unit 8 may identify a device from among each device that has software for the account server installed, and determine that device as an important device (in this example, the account server). For example, based on the information about each device, the important device identification unit 8 may identify a device from among each device that exchanges communication data with other devices using a predetermined protocol, and determine that device as an important device (in this example, an account server). For example, based on the information about each device, the important device identification unit 8 may identify a device from among each device that has a predetermined port open and determine that device as an important device (in this example, an account server).

In the above example, the following conditions are illustrated: “software for an account server is installed,” “the device exchanges communication data with other devices using a predetermined protocol,” and “a predetermined port is open”. The important device identification unit 8 may identify as an account server a device for which two or more of these predetermined conditions are satisfied.

If a device other than the account server is defined as an important device, the conditions applicable to that important device may also be defined in advance. Then, based on the information about each device, the important device identification unit 8 can identify a device from among each device that satisfies the established conditions and determine that device as an important device.

The display control unit 6 displays the attack routes on thedisplay device 7 by superimposing the attack routes on the network topology. At this time, the display control unit 6 displays the attack routes on the display device 7 in a manner that corresponds to the impact of the attack on the system to be diagnosed.

In this example embodiment, the display control unit 6 displays the attack routes that lead to important devices on the display device 7 in a different manner from the attack routes that do not lead to important devices. Important devices are devices that are important in the system to be diagnosed, and it is undesirable for them to be attacked. The impact on the system to be diagnosed by an attack along the attack route leading to the important devices is significant. As described above, by displaying the attack routes leading to the important devices in a different manner from the attack routes that do not lead to the important devices, the display control unit 6 can indicate to the administrator the attack routes that are most likely to be affected by attacks. When there are the plurality of types of important devices or the plurality of important devices of the same type, the display control unit 6 may change the display of the attack routes leading to the important devices for each important device.

For example, the display control unit 6 may display a line that represents an attack route that leads to an important device as a thicker line than a line that represents an attack route that does not lead to an important device. An example of such a display is shown in FIG. 9.

In the example shown in FIG. 9, the display control unit 6 displays the attack route “device a→device e→device b” (referred to as attack route 50, as in the first example embodiment), the attack route “device f→device g” (referred to as attack route 52, as in the first example embodiment). In this example, it is assumed that the important device identification unit 8 identifies only device b shown in FIG. 9 as an important device. In this case, attack route 50 is an attack route that leads to the important device, and attack route 52 is an attack route that does not lead to the important device. Therefore, the display control unit 6 displays the line corresponding to the attack route 50 thicker than the line corresponding to the attack route 52.

Administrator who checks the display exemplified in FIG. 9 can easily identify attack on the important device.

The example shown in FIG. 9 illustrates a case where the thickness of the line corresponding to the attack route 50 that leads to the important device is changed from the thickness of the line corresponding to the attack route 52 that does not lead to the important device. The display control unit 6 may emphasize the attack route 50 leading to the important device by displaying the color of the line corresponding to the attack route 50 leading to the important device in a different color from the line corresponding to the attack route 52 not leading to the important device. An example of the display in this case is shown in FIG. 10. FIG. 10 shows an example of a display in which the display control unit 6 emphasizes the attack route 50 leading to the important device by displaying the line corresponding to the attack route 50 in a darker color than the line corresponding to the attack route 52.

The display control unit 6 may also emphasize the attack route 50 leading to the important device by displaying the line corresponding to the attack route 50 that leads to the important device with a different line type from the line corresponding to the attack route 52 that does not lead to the important device. An example of this display is shown in FIG. 11. In FIG. 11, the line corresponding to the attack route 50 leading to the important device is shown as a dotted line, and the attack route 52 not leading to the important device is shown as a solid line, thus emphasizing the attack route 50 leading to the important device. The line type of the emphasized section may be changed as necessary according to the visibility and the degree of emphasis.

The important device identification unit 8 is realized, for example, by the CPU of the computer that operates according to the analysis program. For example, the CPU may read the analysis program from the program recording medium and operate as the important device identification unit 8 according to the program.

Next, the processing process will be explained. FIG. 12 is a flowchart depicting an example of the processing process of the analysis system 1 of the second example embodiment. Operations similar to those of the first example embodiment are indicated with the same step numbers as in FIG. 7. In addition, explanations are omitted for matters that have already been explained.

Steps S1 to S3 are the same as steps S1 to S3 in the first example embodiment (see FIG. 7), and explanations are omitted.

After step S3, the important device identification unit 8 identifies the important device from among each device included in the system to be diagnosed (step S11).

Next, the display control unit 6 superimposes the attack routes on the network topology and displays the attack route leading to the important device on the display device 7 in a different manner from the attack route that does not lead to the important device (Step S12).

According to this example embodiment, as described above, the display control unit 6 displays the attack routes that lead to important devices on the display device 7 in a different manner from the attack routes that do not lead to important devices. Therefore, the administrator can easily grasp the attack routes leading to the important devices. Important devices are important devices in the system to be diagnosed, and it is not desirable for them to be attacked. The administrator can easily understand the attack routes leading to the important devices, and can consider how to deal with the attack routes.

In the second example embodiment, the display control unit 6 may display the attack routes that lead to important devices in a less conspicuous manner than the attack routes that do not lead to important devices. Since examples of inconspicuous display have already been described, the explanation is omitted here.

### Example Embodiment 3

FIG. 13 is a block diagram of an example of the analysis system of the third example embodiment of the present invention. Elements similar to those of the first and second example embodiments are indicated with the same sign as in FIG. 1 and FIG. 8. The analysis system 1 of the third example embodiment includes a data collection unit 2, a data storage unit 3, a topology identification unit 4, a detection unit 5, an evaluation value derivation unit 9, a risk information storage unit 10, a display control unit 6, and a display device 7.

The data collection unit 2, the data storage unit 3, the topology identification unit 4, the detection unit 5, and the display device 7 are the same as those elements in the first and second example embodiments, and the explanations are omitted.

The evaluation value derivation unit 9 derives an evaluation value that indicates the degree of risk from an attack on an attack route based on the information about the devices on the attack route and the information stored in the risk information storage unit 10. The evaluation value derivation unit 9 derives the evaluation value for each attack route.

The information stored in the risk information storage unit 10 is explained. FIG. 14 is a schematic diagram depicting an example of information stored in the risk information storage unit 10.

The relationship between various types of software and various types of security vulnerabilities is predetermined. The risk information storage unit 10 stores the information indicating the relationship between various software and various vulnerabilities in a table format, for example (see the table shown in the upper part of FIG. 14). The table indicating the relationship between the software and the vulnerabilities is hereinafter referred to as the first table. The administrator may store the first table in the risk information storage unit 10 in advance.

There are two main types of security vulnerabilities. The first is vulnerabilities caused by software or device (routers, etc.) defects. Information on these vulnerabilities is collected and classified by various organizations, and the vulnerabilities are numbered accordingly. As an example, in the Common Vulnerabilities and Exposures (CVE), an identifier of the form “CVE-****-****” is assigned to the discovered vulnerability. The second type of vulnerability is the vulnerability caused by the protocol specification. Examples of such vulnerabilities are “abuse of FTP (File Transfer Protocol)”, “abuse of Telnet”, etc. In each example embodiment of the present invention, the vulnerabilities include these first and second vulnerabilities.

For each vulnerability, the risk information storage unit 10 stores the evaluation value that indicates the degree of risk from the attack using the vulnerability, for example, in a table format (see the table shown in the lower part of FIG. 14). The table indicating the relationship between the vulnerability and the evaluation value is hereinafter referred to as the second table.

The evaluation values stored in the second table may be set for each vulnerability in advance. For example, if the vulnerability is a software or device vulnerability, the risk value in CVSS v3 (Common Vulnerability Scoring System v3) may be used as the evaluation value. CVSS v3 also includes information such as “whether or not the attack requires administrative privileges”, “whether or not the attack requires human involvement”, and “the level of risk to availability”. Depending on these values, the risk value may be corrected and used as the evaluation value. In addition, the risk value in CVSS v3 may be used as the evaluation value by correcting the risk value according to the information such as “whether the vulnerability has been discovered recently” or “whether the vulnerability has been attacked frequently recently”.

In the case of vulnerabilities caused by protocol specifications, such as “Abuse of FTP ”, “Abuse of Telnet”, etc., the administrator may predetermine the evaluation value as appropriate.

As in the above example, the administrator may define the evaluation value in advance for each vulnerability and store the second table in the risk information storage unit 10.

An example of how the evaluation value derivation unit 9 derives the evaluation value for one attack route is explained below. For each device on the attack route of interest, the evaluation value derivation unit 9 checks each software installed on the device and determines each vulnerability corresponding to each software installed on the device by referring to the first table (see FIG. 14). In addition, the evaluation value derivation unit 9 identifies the vulnerability according to the attack route from among the determined vulnerabilities, for each device on the attack route of interest. As already explained, even if there are common devices on different attack routes, the attack states of those devices are not necessarily identical. Therefore, as described above, the evaluation value derivation unit 9 identifies the vulnerability according to the attack route.

After the evaluation value derivation unit 9 identifies a vulnerability for each device on the attack route of interest, the evaluation value derivation unit 9 reads the evaluation value corresponding to the vulnerability for each device from the second table (see FIG. 14). Then, the evaluation value derivation unit 9 derives the evaluation value of the attack route of interest, based on the evaluation values obtained for each device on the attack route. For example, the evaluation value derivation unit 9 may use the sum of the evaluation values obtained for each device on the attack route as the evaluation value of the attack route. Also, for example, the evaluation value derivation unit 9 may use the maximum value of the evaluation values obtained for each device on the attack route as the evaluation value of the attack route.

The evaluation value derivation unit 9 may derive an evaluation value for each attack route using the method described above.

Another example of how to calculate the evaluation value is described below. For each vulnerability, the evaluation value derivation unit 9 calculates how many attack patterns the vulnerability is used in the system to be diagnosed, and the result of the calculation may be defined as the evaluation value of the vulnerability. Here, the attack pattern is the information that includes at least an attack state that is attack condition, an attack state that is attack result, and the vulnerability used in the attack. Then, as described above, the evaluation value derivation unit 9 identifies the vulnerability according to the attack route for each device on the attack route of interest. The evaluation value derivation unit 9 uses the number of attack patterns that use the vulnerability as the evaluation value of the vulnerability identified for each device. In this way, after obtaining the evaluation value for each device on the attack route, the evaluation value of the attack route of interest is derived based on the evaluation value obtained for each device. For example, the evaluation value derivation unit 9 may use the sum of the evaluation values obtained for each device on the attack route as the evaluation value of the attack route. Also, for example, the evaluation value derivation unit 9 may use the maximum value of the evaluation values obtained for each device on the attack route as the evaluation value of the attack route. The evaluation value derivation unit 9 may use this method to derive the evaluation value for each attack route.

The display control unit 6 displays the attack routes on the display device 7 by superimposing the attack routes on the network topology. At this time, the display control unit 6 displays the attack routes on the display device 7 in a manner that corresponds to the impact of the attack on the system to be diagnosed.

In this example embodiment, the display control unit 6 displays each attack route on the display device 7 in a manner corresponding to the evaluation value derived for each attack route. In other words, the display control unit 6 highlights the attack route according to the magnitude of the evaluation value. For example, the display control unit 6 may display each attack route with a line of thickness corresponding to the evaluation value. Specifically, the display control unit 6 may represent the attack route with a thicker line as the evaluation value is larger, and the attack route with a thinner line as the evaluation value is smaller. An example of such a display is shown in FIG. 15.

In the example shown in FIG. 15, the display control unit 6 displays the following attack routes: the attack route “device a→device e→device b” (referred to as attack route 50, as in the first example embodiment), the attack route “device f→device g” (referred to as attack route 52, as in the first example embodiment), and the attack route “device c→device i” (denoted by the sign “53” and referred to as attack route 53). In this example, the display control unit 6 displays the line representing the attack route 50 as the thickest, the line representing the attack route 52 as the thinnest, and the line representing the attack route 53 as the medium thickness.

Therefore, based on the thickness of the displayed lines, the administrator can easily determine that the attack route 50 has the highest evaluation value, the attack route 53 has the second highest evaluation value, and the attack route 52 has the lowest evaluation value. In other words, the administrator can easily determine that the impact of an attack along attack route 50 is the largest, the impact of an attack along attack route 53 is the second largest, and the impact of an attack along attack route 52 is the smallest.

The example shown in FIG. 15 indicates a case where the display control unit 6 displays each attack route with a line of thickness according to the evaluation value. The display control unit 6 may display each attack route with a color according to the evaluation value. Alternatively, the display control unit 6 may display each attack route with a line type according to the evaluation value. In such a case, the administrator can still determine the evaluation value (impact on the system to be diagnosed) of the attack route by the color and line type.

The evaluation value derivation unit 9 is realized, for example, by the CPU of the computer that operates according to the analysis program. For example, the CPU can read the analysis program from a program recording medium and operate as the evaluation value derivation unit 9 according to the program. The risk information storage unit 10 is realized, for example, by a storage device included in the computer.

Next, the processing process is explained. FIG. 16 is a flowchart depicting an example of the processing process of the analysis system 1 of the third example embodiment. Operations similar to those of the first and second example embodiments are indicated with the same step numbers as in FIG. 7 and FIG. 12. In addition, explanations are omitted for matters that have already been explained.

Steps S1 to S3 are the same as steps S1 to S3 in the first and second example embodiments (see FIGS. 7 and 12) and explanations are omitted.

After step S3, the evaluation value derivation unit 9 calculates the evaluation value for each attack route (step S21).

Next, the display control unit 6 superimposes the attack routes on the network topology and displays each attack route on the display device 7 in a manner corresponding to the evaluation value derived for each attack route (Step S22).

According to this example embodiment, the display control unit 6 displays each attack route in a manner corresponding to the evaluation value. Therefore, the administrator can determine the evaluation value (impact on the system to be diagnosed) for each attack route, and as a result, can easily determine the attack route to be dealt with on a priority basis. In other words, the administrator can easily determine the attack route with the large evaluation value (impact on the system to be diagnosed).

In the third example embodiment, when the number of attack routes detected by the detection unit 5 is very large, if the display control unit 6 displays each attack route in a manner according to the evaluation value, the number of displayed attack routes may be large and the display may be difficult for the administrator to see. Therefore, in the third example embodiment, the display control unit 6 may display each attack route on the display device 7 in a manner according to the evaluation value when the number of attack routes detected by the detection unit 5 is equal to or less than a predetermined number. In this case, the number of attack routes to be displayed is limited, which improves the ease of decision making by the administrator.

The display control unit 6 may select a predetermined number of attack routes in the descending order of the evaluation value (in other words, in the descending order of the impact of the attack), and display the selected predetermined number of attack routes on the display device 7 in a manner corresponding to the evaluation value. The display control unit 6 may not display the attack routes that were not selected. In this case, even if the number of attack routes detected by the detection unit 5 is large, a predetermined number of attack routes are selected in the descending order of evaluation value, and the selected attack routes are displayed in a manner corresponding to the evaluation value. Therefore, the number of attack routes to be displayed is limited, and the ease of decision making by the administrator is improved.

In the third example embodiment, the display control unit 6 may inconspicuously display the attack route with a large evaluation value and conspicuously display the attack route with a small evaluation value. Examples of inconspicuous display have already been described, so the explanation is omitted here.

Next, a variation of the third example embodiment is explained. FIG. 17 is a block diagram of a variation of the third example embodiment. In addition to the elements shown in FIG. 13, the analysis system 1 of this variation includes a damage information storage unit 11 and a damage identification unit 12.

The damage information storage unit 11 is a storage device that stores damage information (information that indicates the content of damage suffered when attacked) according to the function of the device and the type of attack.

FIG. 18 is a schematic diagram depicting an example of information stored in the damage information storage unit 11. For example, the damage information storage unit 11 stores a table that associates the function of the device, the attack type, and the damage information, as illustrated in FIG. 18. The attack type can be identified based on the function of the device. The damage information can be identified based on both the function of the device and the attack type, or one of them. For example, the information exemplified in FIG. 18 can be predetermined by the administrator and stored in the damage information storage unit 11.

The damage identification unit 12 identifies the damage information for each device on the attack route. The damage identification unit 12 performs this process for each attack route. However, there may be devices on the attack route for which no damage information is identified.

The following is an example of how the damage identification unit 12 identifies damage information for each device of one attack route. The damage identification unit 12 identifies the function of the device and the attack type for each device of the attack route of interest.

The damage identification unit 12, for example, identifies the function of each device as follows.

The conditions according to the function of the device are defined in advance. For example, for the “account server function,” one, two, or more of the following conditions are predetermined: “software for the account server is installed”, “the device exchanges communication data with other devices using a predetermined protocol”, or “a predetermined port is open”.

For example, for the “human resources information management server function”, the condition that “software for the human resources information management server is installed” is predetermined.

The damage identification unit 12 may identify the function of the device by referring to the information about the device whose function is to be identified and determining whether the information satisfies the conditions corresponding to any function. If the information about the device does not meet the conditions for any of the functions, the damage identification unit 12 may derive the result “No applicable function” as the function of the device.

Using the method described above, the damage identification unit 12 identifies the function of each device on the attack route of interest.

Also, as mentioned earlier, the attack type can be identified based on the function of the device. Therefore, for example, the damage identification unit 12 can identify the attack type based on the correspondence between the function of the device and the attack type, which is known in advance.

However, the damage identification unit 12 may identify the functions of devices in other ways. For example, the damage identification unit 12 may identify the function of each device on the attack route by receiving the designation of the function of each device from the administrator via a user interface (not shown). The same applies to the attack type.

After the damage identification unit 12 has identified the function of the device and attack type for one device on the attack route of interest, the damage identification unit 12 identifies the damage information corresponding to the combination of the function of the device and attack type, for example, by referring to the table (see FIG. 18) stored by the damage information storage unit 11. The damage information can also be identified from one of the function of the device and attack type. Therefore, the damage identification unit 12 may identify damage information corresponding to the function of the device or to the attack type. If the damage information corresponding to the combination of the function of the device and the attack type, or either of them, cannot be identified by referring to the table stored by the damage information storage unit 11 (see FIG. 18), the damage identification unit 12 determines that there is no damage information for the device. The damage identification unit 12 performs this operation for each device on the attack route of interest. As a result, the damage information for each device on the attack route of interest is determined.

The damage identification unit 12 performs the same operation as above for each attack route, and identifies damage information for each device on each attack route. However, as mentioned above, there may be devices for which no damage information is identified.

In the above explanation, a case, where the damage identification unit 12 determines the damage information based on the function of the device and the attack type, has been shown. The damage identification unit 12 may define the damage information in other ways. For example, it is possible to associate the vulnerability type to the damage information in advance. The damage identification unit 12 may identify the vulnerability type based on the software installed on each device on each attack route, and identify the damage information based on the vulnerability type.

The damage identification unit 12 performs the above process, for example, following step S21 (see FIG. 16) in the third example embodiment.

Then, in step S22 (see FIG. 16), the display control unit 6 displays each attack route as described in the third example embodiment, and also displays damage information (i.e., information indicating the damage content to be suffered in the event of an attack) in the vicinity of the device for which the damage information was identified. An example of such a display is shown in FIG. 19. In the example shown in FIG. 19, damage information is identified for devices e, b on the aforementioned attack route 50 and device i on the aforementioned attack route 53, respectively, and the display control unit 6 displays the corresponding damage information in the vicinity of the devices e, b, and i, respectively, on the display device 7. Here, the display control unit 6 may display each attack route as described in the third example embodiment, as well as information on security such as the vulnerability of the device in the vicinity of the device.

The display control unit 6 may change the size and color of the text and pop-ups according to the magnitude of the damage content indicated by the damage information. For example, the content of the damage information may be ranked in advance, and the display control unit 6 may set the size and color of the text and pop-ups according to the rank when displaying the damage information.

The display format of damage information is not limited to the above example. For example, the display control unit 6 may display an icon near the device for which damage information has been identified, indicating that damage information is related to that device. When the icon is clicked by a mouse and the like, the display control unit 6 may display the damage information about the device. Alternatively, the display control unit 6 may display damage information about the device when the icon is in mouse-over state (rollover). The display control unit 6 may also display damage information in a pop-up window and change the size of the pop-up window according to the operation by the mouse and the like.

The display control unit 6 may also highlight and display damage information for devices on the plurality of attack routes. FIG. 20 is a schematic diagram depicting an example of highlighting and displaying damage information for a device on the plurality of attack routes. As shown in FIG. 20, suppose that the attack route 50, “Device a→Device e→Device b”, and the attack route 51, “Device c→Device e→Device d”, are overlapped, and that Device e exists in the overlapped section. In other words, device e exists on the plurality of attack routes 50 and 51. Device b exists on one attack route 50. Then, the damage information for device e and device b shown in FIG. 20 has been identified. In this case, the display control unit 6 emphasizes the damage information of device e, which exists on the plurality of attack routes 50 and 51, over the damage information of device b, as shown in FIG. 20.

The example shown in FIG. 20 illustrates a case where the damage information of device e is emphasized by thickening the balloon line. This is also the case in FIG. 21, below.

The display control unit 6 may also highlight damage information related to important device. FIG. 21 is a schematic diagram depicting an example of highlighting damage information regarding an important device. In the example shown in FIG. 21, it is assumed that damage information for device b and device i has been identified. In addition, assume that device b is an important device and device i is not an important device. In this case, the display control unit 6 displays the damage information of device b with more emphasis than that of device i, as shown in FIG. 21.

The damage identification unit 12 is realized, for example, by the CPU of the computer that operates according to the analysis program. For example, the CPU may read the analysis program from the program recording medium and operate as the damage identification unit 12 according to the program. The damage information storage unit 11 is realized, for example, by a storage device included in the computer.

According to this variation, the display control unit 6 also displays damage information near the device on the display device 7, which indicates the damage to be suffered if the device on the attack route is attacked. Therefore, the administrator can determine which attack route should be dealt with in priority according to the assumed damage.

The variations described with reference to FIGS. 17 to 21 can be applied to the first and second example embodiments. For example, in the first and second example embodiments, the analysis system 1 may include a risk information storage unit 10, a damage information storage unit 11, and a damage identification unit 12. Then, the display control unit 6 may also display, on the display device 7, damage information indicating the damage to be suffered when a device on the attack route is attacked, in the vicinity of the device. In this case, the risk information storage unit 10 only needs to store the first table (see FIG. 14) and not the second table (see FIG. 14). When applying the above variation to the first example embodiment, the display control unit 6 may display the damage information of a device that exist in the overlapped section of the plurality of attack routes with more emphasis than the damage information of other devices. When the above example is applied to the second example embodiment, the display control unit 6 may emphasize the damage information of important devices more than that of other devices.

Either or both of the second and third example embodiments may be applied to the first example embodiment. When applying the third example embodiment to the first example embodiment, the display control unit 6 may define the thickness of the line corresponding to the overlapped section of the plurality of attack routes according to the plurality of attack routes. Specifically, the display control unit 6 may set the thickness of the line corresponding to the overlapped section of the plurality of attack routes to the thickness corresponding to the sum of the evaluation values for each of the plurality of attack routes.

Various examples of combining the first example embodiment with the second example embodiment are described below.

When combining the first example embodiment with the second example embodiment, the display control unit 6 may, if there are overlapped section of the plurality of attack routes leading to the important device, display the overlapped section with special emphasis.

The display control unit 6 may also emphasize the overlapped section of the plurality of attack routes by the thickness of the line, and emphasize the attack route leading to the important device by the color of the line. In this example, the method of emphasizing the overlapped section and the method of emphasizing the attack route leading to the important device may be reversed. According to this example, for example, the administrator can understand that for the attack routes that have section that is emphasized in both thickness and color, special priority should be given to addressing vulnerabilities.

The third example embodiment may also be applied to the second example embodiment.

Various examples of the application of the third example embodiment to the second example embodiment are described below. If the evaluation value of an attack route leading to an important device is large, the display control unit 6 may display the attack route with special emphasis. FIG. 22 is a schematic diagram of an example display in this case. In the example shown in FIG. 22, the attack routes 50, 52, and 53 are displayed with thicknesses corresponding to their respective evaluation values. Here, it is assumed that the evaluation value of the attack route 50 is a particularly large value. Also, it is assumed that device b shown in FIG. 22 is an important device. Then, the attack route 50 with the large evaluation value is also the attack route leading to the important device. Therefore, the display control unit 6 not only displays the attack route 50 with a thick line according to the evaluation value, but also emphasizes the attack route 50 by making the thick line a dotted line. The method of emphasis is not limited to the example shown in FIG. 22.

The display control unit 6 may also highlight the attack routes leading to important devices, even if the evaluation value is small. This display style is based on the idea that an attack on an attack route leading to an important device will have a large impact regardless of the evaluation value.

Alternatively, the display control unit 6 may display the attack route leading to the important device with a lower degree of emphasis if the evaluation value is small. This display style is based on the idea that even if an attack route leads to an important device, if the evaluation value is small, the impact of the attack is small and the priority of the action may be lowered.

For attack routes that do not lead to important devices, the display control unit 6 may display them without emphasis, even if the evaluation value is large. This display style is based on the idea that since the importance of the attack target is low, the priority of the action may be lowered.

Alternatively, the display control unit 6 may emphasize the attack routes that do not lead to important devices, if the evaluation value is large, according to the evaluation value. This display style is based on the idea that if the evaluation value of the attack route itself is large, the impact of the attack is large and should be dealt with in priority order according to the evaluation value.

In this way, the display control unit 6 may display the attack routes in various ways, depending on various ideas about the priority of action.

FIG. 23 is a schematic block diagram of a computer configuration for the analysis system 1 of each example embodiment of the present invention. The computer 1000 includes a CPU 1001, a main storage device 1002, an auxiliary storage device 1003, an interface 1004, a display device 1005, and a communication interface 1006.

The analysis system 1 of each example embodiment of the present invention is realized by a computer 1000. The operation of the analysis system 1 is stored in the auxiliary storage device 1003 in the form of an analysis program. The CPU 1001 reads the analysis program from the auxiliary storage device 1003, expands it to the main storage device 1002, and executes the processing described in each of the above example embodiments according to the analysis program.

The auxiliary storage device 1003 is an example of a non-transitory tangible medium. Other examples of non-transitory tangible media include a magnetic disk, a magneto-optical disk, CD-ROM (Compact Disk Read Only Memory), DVD-ROM (Digital Versatile Disk Read Only Memory), semiconductor memory, and the like, which are connected via an interface 1004. When the program is delivered to the computer 1000 via a communication line, the computer 1000 receiving the delivery may expand the program into the main memory device 1002 and execute the processing described in each of the above example embodiments according to the program.

Some or all of the components may be realized by general-purpose or dedicated circuitry, processors, or a combination of these. They may be configured with a single chip, or configured with the plurality of chips connected via a bus. Some or all of each component may be realized by a combination of the above-mentioned circuitry, etc. and programs.

When some or all of each component is realized by the plurality of information processing devices, circuitry, etc., the plurality of information processing devices, circuitry, etc. may be centrally located or distributed. For example, the information processing devices, circuitry, etc. may be implemented as a client-and-server system, cloud computing system, etc., each of which is connected via a communication network.

Next, an overview of the present invention will be described. FIG. 24 is a block diagram depicting an overview of an analysis system according to the present invention. The analysis system of the present invention is an analysis system that virtualizes and simulates a system to be diagnosed. The analysis system of the present invention includes a topology identification unit 4, a detection unit 5, and a display control unit 6.

The topology identification unit 4 identifies a network topology of devices included in the system to be diagnosed.

The detection unit 5 detects attack routes that indicate flows of attacks that can be executed in the system to be diagnosed, based on security information about each device.

The display control unit 6 displays the attack routes on a display device by superimposing the attack routes on the network topology. At this time, the display control unit 6 displays the attack routes on the display device in a manner that corresponds to impact on the system to be diagnosed.

With such a configuration, it is possible to evaluate threats to security according to the configuration of the system to be diagnosed.

The above example embodiments of the present invention can be described as, but not limited to, the following supplementary notes.

(Supplementary Note 1)
An analysis system that virtualizes a system to be diagnosed and performs a simulation, comprising:

a topology identification unit that identifies a network topology of devices included in the system to be diagnosed;

a detection unit that detects attack routes that indicate flows of attacks that can be executed in the system to be diagnosed, based on security information about each device; and,

a display control unit that displays the attack routes on a display device by superimposing the attack routes on the network topology,

wherein the display control unit displays the attack routes on the display device in a manner that corresponds to impact on the system to be diagnosed.

(Supplementary Note 2)
The analysis system according to supplementary note 1,

wherein the display control unit displays an overlapped section of the plurality of attack routes on the display device in a different manner from sections of each attack route where the plurality of attack routes are not overlapped.

(Supplementary Note 3)
The analysis system according to supplementary note 1 or 2,

where the display control unit displays a line corresponding to the overlapped section of the plurality of attack routes on the display device in a different manner from lines corresponding to sections of each attack route where the plurality of attack routes are not overlapped.

(Supplementary Note 4)

The analysis system according to any one of supplementary notes 1 to 3,

wherein the display control unit displays an attack route that leads to an important device in a different manner from an attack route that does not lead to the important device.

(Supplementary Note 5)

The analysis system according to any one of supplementary notes 1 to 4, further comprising:

an important device identification unit that identifies an important device from among each device included in the system to be diagnosed,

wherein the display control unit displays an attack route that leads to the important device in a different manner from an attack route that does not lead to the important device.

(Supplementary Note 6)

The analysis system according to any one of supplementary notes 1 to 5, further comprising:

an evaluation value derivation unit that derives an evaluation value that indicates degree of risk from an attack, for each attack route,

wherein the display control unit displays each attack route on the display device in a manner corresponding to the evaluation value.

(Supplementary Note 7)
The analysis system according to supplementary note 6,

wherein the display control unit displays each attack route on the display device in a manner corresponding to the evaluation value when the number of attack route is equal to or less than a predetermined number.

(Supplementary Note 8)

The analysis system according to supplementary note 6,

wherein the display control unit selects a predetermined number of attack routes in descending order of the degree of risk from the attack, and displays the predetermined number of attack routes in a manner corresponding to the evaluation value.

(Supplementary Note 9)

The analysis system according to any one of supplementary notes 1 to 8, further comprising:

a damage identification unit that identifies damage information that indicates content of damage of devices on the attack routes when the devices are attacked,

wherein the display control unit displays the damage information in the vicinity of the devices on the attack routes.

(Supplementary Note 10)

An analysis method of virtualizing a system to be diagnosed and performing a simulation, implemented by a computer, comprising:

identifying a network topology of devices included in the system to be diagnosed;

detecting attack routes that indicate flows of attacks that can be executed in the system to be diagnosed, based on security information about each device; and,

displaying the attack routes on a display device by superimposing the attack routes on the network topology,

wherein when displaying the attack routes on the display device the computer displays the attack routes on the display device in a manner that corresponds to impact on the system to be diagnosed.

(Supplementary Note 11)

A computer-readable recording medium in which an analysis program is recorded, the analysis program causing a computer to virtualize a system to be diagnosed and performs a simulation,

the analysis program causing the computer to execute:

a topology identification process of identifying a network topology of devices included in the system to be diagnosed;

a detection process of detecting attack routes that indicate flows of attacks that can be executed in the system to be diagnosed, based on security information about each device; and,

a display control process of displaying the attack routes on a display device by superimposing the attack routes on the network topology,

wherein the analysis program causes the computer to execute,

in the display control process, displaying the attack routes on the display device in a manner that corresponds to impact on the system to be diagnosed.

Although the invention of the present application has been described above with reference to example embodiments, the present invention is not limited to the above example embodiments. Various changes can be made to the configuration and details of the present invention that can be understood by those skilled in the art within the scope of the present invention.

This application is based upon and claims the benefit of priority from Japanese patent application No. 2019-063597 filed on Mar. 28, 2019, the disclosure of which is incorporated herein in its entirety by reference.

### INDUSTRIAL APPLICABILITY

This invention is suitably applied to analysis systems that display attack routes.

### REFERENCE SIGNS LIST

1 Analysis system

2 Data collection unit

3 Data storage unit

4 Topology identification unit

5 Detection unit

6 Display control unit

7 Display device

8 Important device identification unit

9 Evaluation value derivation unit

10 Risk information storage unit

11 Damage information storage unit

12 Damage identification unit

What is claimed is:

1. An analysis system that virtualizes a system to be diagnosed and performs a simulation, comprising:
a topology identification unit that identifies a network topology of devices included in the system to be diagnosed;
a detection unit that detects attack routes that indicate flows of attacks that can be executed in the system to be diagnosed, based on security information about each device; and,
a display control unit that displays the attack routes on a display device by superimposing the attack routes on the network topology,
wherein the display control unit displays the attack routes on the display device in a manner that corresponds to impact on the system to be diagnosed.

2. The analysis system according to claim 1,
wherein the display control unit displays an overlapped section of the plurality of attack routes on the display device in a different manner from sections of each attack route where the plurality of attack routes are not overlapped.

3. The analysis system according to claim 1,
where the display control unit displays a line corresponding to the overlapped section of the plurality of attack routes on the display device in a different manner from lines corresponding to sections of each attack route where the plurality of attack routes are not overlapped.

4. The analysis system according to claim 1,
wherein the display control unit displays an attack route that leads to an important device in a different manner from an attack route that does not lead to the important device.

5. The analysis system according to claim 1, further comprising:
an important device identification unit that identifies an important device from among each device included in the system to be diagnosed,
wherein the display control unit displays an attack route that leads to the important device in a different manner from an attack route that does not lead to the important device.

6. The analysis system according to claim 1, further comprising:
an evaluation value derivation unit that derives an evaluation value that indicates degree of risk from an attack, for each attack route,
wherein the display control unit displays each attack route on the display device in a manner corresponding to the evaluation value.

7. The analysis system according to claim 6,
wherein the display control unit displays each attack route on the display device in a manner corresponding to the evaluation value when the number of attack route is equal to or less than a predetermined number.

8. The analysis system according to claim 6,
wherein the display control unit selects a predetermined number of attack routes in descending order of the degree of risk from the attack, and displays the predetermined number of attack routes in a manner corresponding to the evaluation value.

9. The analysis system according to claim 1, further comprising:
a damage identification unit that identifies damage information that indicates content of damage of devices on the attack routes when the devices are attacked,
wherein the display control unit displays the damage information in the vicinity of the devices on the attack routes.

10. An analysis method of virtualizing a system to be diagnosed and performing a simulation, implemented by a computer, comprising:
identifying a network topology of devices included in the system to be diagnosed;
detecting attack routes that indicate flows of attacks that can be executed in the system to be diagnosed, based on security information about each device; and,
displaying the attack routes on a display device by superimposing the attack routes on the network topology,
wherein when displaying the attack routes on the display device the computer displays the attack routes on the display device in a manner that corresponds to impact on the system to be diagnosed.

11. A non-transitory computer-readable recording medium in which an analysis program is recorded, the analysis program causing a computer to virtualize a system to be diagnosed and performs a simulation,
the analysis program causing the computer to execute:
a topology identification process of identifying a network topology of devices included in the system to be diagnosed;
a detection process of detecting attack routes that indicate flows of attacks that can be executed in the system to be diagnosed, based on security information about each device; and,
a display control process of displaying the attack routes on a display device by superimposing the attack routes on the network topology,
wherein the analysis program causes the computer to execute,
in the display control process, displaying the attack routes on the display device in a manner that corresponds to impact on the system to be diagnosed.
